(19) United States
(12) Patent Application Publication
(10) Pub. No.: US 2005/0268804 A1
(43) Pub. Date: Dec. 8, 2005

(54) Lithographic method for small line printing

(75) Inventors: David Van Steenwinckel, Leuven (BE); Jeroen Herman Lammers, Leuven (BE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/525,863

(22) PCT Filed: Aug. 18, 2003
(86) PCT No.: PCT/IB03/03663

§ 371 Date: Feb. 25, 2005

(30) Foreign Application Priority Data
Aug. 30, 2002 (EP) 02078577.0

(51) Int. Cl. B41C 1/00

(52) U.S. Cl. 101/483

(57) ABSTRACT

The minimal feature width (CD) of a pattern of device features configured in a substrate layer by means of a lithographic process can be reduced considerably, without reducing process latitudes (DOF), by substantially extending the post-exposure bake step and reducing the exposure dose. By the same measures the isofocal CD can be tuned to the design CD so that for an arbitrary CD process latitudes are enlarged.

The invention relates to a method of forming a pattern of features having sub-micron width in a device substrate layer, which method includes the steps of

forming a resist layer of one of the resist types: positive resist and negative resist on the substrate;

providing a mask having a mask pattern corresponding to the pattern of features to be formed in the substrate layer;

illuminating the resist layer via the mask pattern by means of a projection beam providing an exposure dose, thereby generating an acid concentration profile in the resist layer around each imaged feature;

heating the illuminated resist layer during a post exposure baking (PEB) step so that, starting from the highest illumination intensity areas, the material of a positive resist layer becomes soluble and the material of a negative resist layer becomes insoluble, respectively in a developer solution;

developing the resist layer in the developer solution so that resist material is removed from resist layer areas having a solubility above a threshold value so that a resist profile pattern is obtained, and

removing material from or adding material to areas of the substrate layer, which areas are delineated by the resist profile pattern so that the required pattern of features is formed in the substrate layer.

The invention also relates to a method of manufacturing a device, using this patterning method and to a device manufactured by means of the method.

This method may be used, amongst others, in the manufacture of devices, like integrated circuits (ICs), by means of masking, material removing and implantation techniques.

A positive resist layer is understood to mean a resist layer of which illuminated areas are removed during the developer step. A negative resist layer is understood to mean a resist layer of which non-illuminated areas are removed during the developer step.

A substrate is understood to mean a plate of material, for example silicon, into which a complete multilevel device, such as an IC, is to be formed level by level by means of a number of successive sets of processing steps. Each of these sets comprises as main processing steps: coating a radiation sensitive, or resist, layer on the substrate, aligning the substrate with a mask, imaging the mask pattern of this mask in the resist layer, developing the resist layer, etching or implantation of the substrate via the resist layer and further cleaning and other processing steps. The term substrate covers substrates at different stages in the manufacture process, i.e. both a substrate having no or only one level of already configured device features and a substrate having all but one level of already configured device features, and all intermediate substrates.

The method uses a lithographic projection apparatus, which apparatus is an essential tool in the manufacture of ICs. The projection apparatus is used to image successively different mask patterns at the same area of a semiconductor substrate, each mask pattern at a different level, or in a different layer, of the substrate. This apparatus includes, in this order, an illumination unit for supplying a projection beam, a mask holder for accommodating a mask, a substrate holder for accommodating a substrate and a projection system arranged between the mask holder and the substrate holder. The mask is provided with a mask pattern corresponding to the pattern of device features that is to be formed in that substrate layer that is to be configured by the specific mask pattern. The projection system, which may be a system of lenses or a system of mirrors or a combination of such systems, forms an image, known as aerial image, of the mask pattern on a resist layer coated on the substrate. The aerial image shows an intensity distribution corresponding to the mask pattern.

In the illuminated, or exposed, areas of the resist layer an acid is generated, which acid is partly neutralized by a quencher. Usually the exposure step is followed by a step of baking the resist layer, which step is called the post-exposure baking (PEB) step. In a positive resist layer, the thermal activation by means of the PEB step causes the remaining acid to start removing solubility-blocking groups, which are present in the polymer chain of the resist. The effect of this action, which is known as de-protecting the resist, is that the resist becomes soluble in an aqueous developer once the de-protection action has taken place up to a given extent, or has reached a threshold level. This means that, for a given duration of the PEB step, the resist polymer will become soluble in those areas where the aerial image intensity exceeds a given threshold intensity. In a negative resist layer the thermal activation causes protection of the resist, i.e. soluble resist that is soluble in a developer solution becomes insoluble.

Since it is desirable to steadily increase the number of electronic components in an IC device and the operating speed of such a device, the minimum width of the device features, or -lines, also called the critical dimension (CD), and the distance between these features should steadily be decreased. As a consequence, mask patterns with increasingly smaller pattern features and smaller distances between these features should be imaged. The minimum size of pattern features, which can be imaged with the required quality by a lithographic projection apparatus, depends on the resolving power, or resolution, of the projection system of this apparatus and the structure of the mask pattern. This resolution is proportional to λ/NA, wherein λ is the wavelength of the projection beam and NA is the numerical aperture of the projection system. Increasing the numerical aperture and/or decreasing the wavelength could increase the resolution. In practice, an increase of the numerical aperture, which is fairly large in current lithographic projection apparatus, is not very well possible because this reduces the depth of focus of the projection system, which is proportional to λNA². Moreover, it becomes too difficult to correct the projection system for aberrations across the entire required image field if the numerical aperture is further increased. Reducing the wavelength in the deep UV (DUV) region from 193 nm, as used in current lithographic projection apparatus, to 157 nm, for example, poses new problems with respect to materials for the optical elements of the projection system and to resist materials, which are sufficient sensitive to radiation of this wavelength. For a next generation of lithographic projection apparatus it has been proposed to use extreme UV (EUV) radiation with a wavelength in the order of 13 nm. It is true that use of such radiation allows imaging of considerably finer pattern structure, but the design and development of an EUV projection apparatus is a very challenging and time consuming task. As EUV radiation is easily absorbed by air, the path of the projection beam should be in vacuum, which poses specific and new problems. A suitable and efficient EUV radiation source is not available yet and also new resist materials, sensitive to EUV radiation have to be developed. An EUV lithographic projection apparatus suitable for the production of ICs, or other devices, will not become available in the next years.

Thus, there is a large need for a method of manufacturing of devices having device features, or -lines, considerably smaller than those of currently manufactured devices, which method uses a conventional projection apparatus and masks patterns having conventional feature sizes. Configuring such small lines, having a width smaller than 100 nm, in a device substrate layer may also be called very small line (VSL) printing.

For printing such very small lines from conventional mask patterns, the exposure dose, i.e. the amount of electromagnetic energy used for imaging a line, could be increased to an over-exposure level. The effect of over-exposure is that the amount of acid molecules, which remove the solubility-blocking groups from the positive resist polymer chain, increases and that these molecules can reach resist regions close to the center of a line to be printed. This center corresponds to an intensity minimum in the aerial image projected on the resist layer, which minimum corresponds to a black line of a binary mask pattern, i.e. a black and white pattern. In this way resist regions under the aerial image line become soluble so that, after developing and etching of the resist layer, the obtained device feature in the substrate layer is smaller than the corresponding line in the aerial image.

However, the width of device features obtained by means of the over-exposure process is extremely dependent on focus variations in the projection system. If the projection beam is focused on the resist layer, the features of the aerial image projected on this layer have minimum dimensions. If the focus plane of the projection system shifts with respect to the resist layer, the mask pattern is no longer sharply imaged on the resist layer and the dimensions of the imaged features in the resist layer increase. This means that the maximum intensities in the aerial image received by the resist layer decreases, which results in increased line width in case a positive resist is used. A second problem that may occur with over-exposure is line collapse, i.e. the required pattern feature, or -line vanishes, due to over-development and subsequently over-etching. A third problem with over-exposure is that resist on the top of a required resist profile gets lost, which may result in unwanted etching of a required pattern feature.

The above-mentioned problems may be reduced by using extreme off-axis, or skew, illumination of the resist layer, such as the well-known dipole or quadrupole illumination, or by using phase-shifting mask patterns, instead of binary mask patterns. However, the image quality obtained with off-axis illumination is extremely dependent on the orientation of the pattern features and on the periodicity, or pitch, of features in the pattern. Phase-shifting masks are very expensive compared with binary masks, which is prohibitive especially if the number of IC devices to be produced by means of a specific mask is not very large.

Another problem encountered with lithography methods in general is that the size of the features configured in the substrate layer should be equal to M times the target size, M being the magnification of the projection system. The target size is fixed in the IC design, thus in the mask pattern, and is called hereinafter the design width. Irregularities in the lithographic process, of which focus variations and exposure dose variations are the most important ones, may cause differences between the actual size and the target size. Focus variations may not only be caused by imperfections of the projection system, but may also result from projecting an aerial image on a resist layer which shows a topography due to feature patterns configured in lower substrate layers by means of preceding lithographic processes. However, for each lithographic process there is a specific feature size, called isofocal CD, for which relatively large focus and dose variations can be tolerated, because they have a relatively small influence on the size of the feature being configured. This isofocal CD is strongly dependent on the resist used and on the neighborhood structure of the feature in the design pattern and thus in the aerial image. Unfortunately, the isofocal CD usually is not equal to the feature size in the design pattern. This means that the lithographic process latitudes, i.e. process tolerances, are very small and that very high requirements have to be set to the depth of field of the projection system and to the exposure dose.

It is an object of the invention to provide a method of the type described in the opening paragraph, which method allows configuring patterns of features having a width smaller than 100 nm and/or has large process latitudes. This method is characterized in that the time duration of the PEB step and the exposure dose are adapted to the design width of the features to be formed.

The invention is based on the insight that the PEB time duration can be used as a tuning process parameter. For, this time duration, in addition to the exposure dose, determines to which distance from a resist region of minimum illumination acid molecules, generated in regions of maximum illumination, can diffuse through the resist. Thus the PEB time duration is used to control the size of the resist areas which are made soluble and will be removed in the developing step. This holds for a positive resist layer. In the case of a negative resist layer the PEB time duration controls the extent to which soluble resist becomes insoluble. Said insight can be used to solve the above-mentioned problems.

An embodiment of the method, wherein during the PEB step transitions between non-soluble and soluble resist material initially have a negative slope, is characterized in that an enlarged PEB time duration is used to push the slopes to at least zero slopes and preferably positive slopes.

In currently used lithographic processes wherein the PEB time duration is, for example, 90 sec, the acid concentration profile in the resist layer has negative slopes, which means that the transitions between non-soluble and soluble resist material have a negative slope. For a positive resist a negative slope means than the top surface area of a required, non-soluble resist, feature is larger than its base area Such a resist feature is less stable during the developing step than a resist feature having positive slopes, i.e. having a top surface area smaller than its base area For a negative resist feature a negative slope means that the top surface area of a required, soluble, resist feature is smaller than its base, which may cause difficulties in removing the soluble resist portion. As the PEB step changes the acid concentration profile in the resist layer and thus the position and slopes of the transition between non-soluble and soluble resist material, the PEB time duration can be used as a process parameter to change the slopes from negative slopes to at least zero slopes and preferably positive slopes.

The method may be further characterized in that a resist layer having a thickness in the range of 300 to 350 nm is used.

It has been found that use of the method in combination with a resist layer having a thickness of the order of 300 nm, for example in the range of 320 to 330 nm, provides excellent results.

The method may be further characterized in that a resist having an adapted radiation absorption gradient is used to reduce changes in the slopes of transitions between non-soluble and soluble resist material, which are due to extended PEB time duration.

This method can be used if a specific slope, for example of 90°, is required for the transitions between non-soluble and soluble resist material. A slope of 90° means that a fictive wall separating non-soluble and soluble resist material is perpendicular to the surface planes of the resist layer. For a lithographic process which is designed such that such a slope is obtained by using a conventional PEB time of 90 sec, the slope will change when using a longer PEB time. For example, when a PEB time of 180 sec is used, a positive slope of 80° will be obtained (for a positive resist). This is due to absorption of exposure radiation by the resist layer, which causes the exposure intensity at the top of the layer to be higher than at the base of the layer. According to the invention for a positive resist so-called surface inhibition may be used so that less radiation is absorbed at the top of the resist. For a negative resist resist surface enhancement may be used, together with developing the resist with a higher concentration developer than usual.

Using a longer PEB time may affect the throughput of the lithographic process. Throughput is understood to mean the number of substrates that can be processed in a unit of time. The exposure time of a lithographic projection (exposure) apparatus is for example 90 sec. If, as is usual in a conventional process the PEB time is also 90 sec, a steady flow of exposed substrates from the exposure apparatus to the PEB device, also called hot plate, can be maintained. If the PEB time is, for example 260 sec, a substrate that has been exposed has to wait 170 sec before it can be placed in the PEB device, which means that the throughput of the process is considerably decreased.

According to the invention the high throughput can be maintained if the method is further characterized in that for carrying out the PEB steps for successively illuminated substrates a number of PEB devices is used, which number corresponds to the ratio of the PEB time duration and the exposure time for one substrate.

For the given example with an exposure time of 90 sec, inclusive of alignment of the substrate relative to the mask pattern and a PEB time of 260 sec, three PEB devices may be used. If, for example, a first exposed substrate is transported to the first PEB device, a second exposed substrate to the second PEB device, a third exposed substrate to the third PEB device, a fourth exposed substrate to the first PEB device and so on, the original high throughput can be maintained, effective use being made of the fact that at an IC (device) manufacturing site, also called a Fab, a number of hot plates are present, which are not in use simultaneously. In the new method the hot plates are used during time intervals which partly overlap.

A general problem encountered in lithographic processes is that the feature printed from a dense line having a given design CD, thus a CD in a mask pattern, is broader than the printed feature from an isolated line having the same design CD. An isolated line, or feature, is understood to mean a feature having no neighboring features in a surrounding area of a size of the order of the feature width. A dense line, or feature is understood to mean a feature, which forms part of a series of features at a mutual distance in the order of the width of the feature. For example, an isolated feature having a design CD of 100 nm is printed as a feature having a width of 90 nm, whilst a dense feature print has a width of 110 nm. To solve this problem, i.e. reduce or eliminate the difference in printed width, the isodense bias principle can be used. This principle is based on optical proximity correction (OPC). OPC means that in the neighborhood of a design device feature one or more additional features are arranged. The additional features are so small that they are not imaged as such, but they do influence the wave front of the exposure beam portion that images the design feature and thus the image of the design feature. By means of specific OPC features in the mask pattern the printed feature width from a dense feature and from an isolated feature can be made equal to each other.

However, it was discovered that an increase of the PEB time causes an increase of the difference between the width of a printed dense feature and the width of a printed isolated feature. For example, if the PEB time is increased from 90 sec to 260 sec, the width of the printed isolated feature will be 100 nm and that of the printed dense feature will be 130 nm. The original OPC features cannot correct the difference in width.

This problem will be eliminated if the method is further characterized in that in the design stage the envisaged PEB time duration is used as a design parameter to determine the design width of the design pattern of features.

The OPC features for printed feature width correction can now be adapted to the PEB time to be used so that the width difference can be eliminated again. In this way a further refinement of the method is obtained. It is also possible to adapt other OPC features, which are used for purposes other than printed line width control, to the PEB time duration chosen.

According to a first aspect of the invention the method is characterized in that the time duration of the PEB step is enlarged to form device features having a smallest dimension, which is smaller than the corresponding smallest dimension of an aerial image of the mask pattern, the aerial image being formed by the projection beam in the resist layer.

In this embodiment of the method the PEB time is used as a means to control the width of the device features to be formed, especially to reduce this width by enlarging the PEB time.

This embodiment is preferably further characterized in that the PEB step is performed during at least 140 seconds and that a correspondingly smaller exposure dose is used to obtain feature widths smaller than 80 nm.

By using a smaller exposure dose the amount of acid molecules is reduced, especially in the neighborhood of the minimum intensity regions and the threshold value of this amount to effect de-protection of a positive resist is reached at a larger distance from the minimum intensity regions. At such a larger distance the aerial image intensity is much less sensitive to focus variations. A considerable increase of the PEB time duration from the standard 90 seconds to longer than 140 seconds, for example 260 seconds, allows also the small amount of acid molecules present in the areas close to the minimum intensity regions to de-protect the resist. Thus also the resist close to the center of the minimum intensity regions becomes soluble so that the width of the pattern features is decreased, despite the low exposure dose used. The great advantage of this method is that for the low exposure dose range the intensity variation due to focus variation is much smaller. Since the (longer) PEB step and the (more efficient) use of the acid are not sensitive to focus errors caused by the projection apparatus, it becomes possible to print very small, for example 40 nm broad, lines with relative large process latitudes.

The above holds for a positive resist. Similar effects occur in a negative resist on the understanding that the resist becomes protected, instead of de-protected.

In this way the possibility to print in a controllable and reliable way ever decreasing line widths by means of conventional lithographic tools is substantially enlarged.

The above-mentioned line width of 40 nm is given as an example of what is possible. The invention can also be used to print line width larger than 40 nm and smaller than the width obtainable by conventional means. The elongation of the PEB time depends on the minimum line width to be printed, the larger this width, the smaller the required elongation is. The said 260 sec PEB time is eminently suitable to print 40 nm broad lines. For printing line width from 40 nm up to 80 nm, which is still very small, PEB time durations from 260 sec up to 140 sec, which is still pretty much larger than the conventional PEB time duration, may be used.

According to a second aspect of the invention the method is characterized in that the isofocal CD is tuned to the design CD by adapting the PEB time duration and the exposure dose.

In this way, large process latitudes for printing both very small and larger design CDs are obtained. Tuning the isofocal CD to the design CD is understood to mean not only that the isofocal is made equal to the design CD, but also that the isofocal CD is brought more closely to the design CD.

A first embodiment of the method is characterized in that use is made of a binary mask pattern.

A binary mask, which may comprise a transparent substrate and a pattern of, for example, chromium features on one side thereof, is the cheapest type of lithographic mask. Using such a mask in combination with the new method can substantially reduce the minimum line width that can be printed with such a mask and/or can enlarge the printing process latitudes considerably.

A second embodiment of the method is characterized in that use is made of a phase shifting mask pattern.

The phase shifting mask may be a pure phase shifting mask, also called a chrome-less mask. In such a mask the borders of the device features are marked by small areas, which introduce phase shifts in the projection beam. The phase shifting mask may also be a mask wherein the device features are non-transparent, for example chromium, features, the borders of which are marked by phase shifting areas. The phase shifted beam portions of a mask feature interfere with each other to form an image feature that may be considerably smaller than the image feature that can be obtained from the same mask feature on a binary mask. Using a phase shifting mask in combination with the new method can further reduce the printable line width and/or can enlarge printing-process latitudes considerably.

The invention also relates to a method of level-by-level manufacturing of a device, which comprises device features distributed over different levels, which method employs a number of processes for configuring device features, each process for one device level. This method is characterized in that at least one of the configuring processes comprises the method as described hereinbefore.

As the new pattern forming method results in a device having smaller minimum device features and/or better defined feature sizes, the invention is also embodied in such a device.

These and other aspects of the invention are apparent from and will be elucidated by way of non-limitative example with reference to the embodiments described hereinafter.

In the drawings:

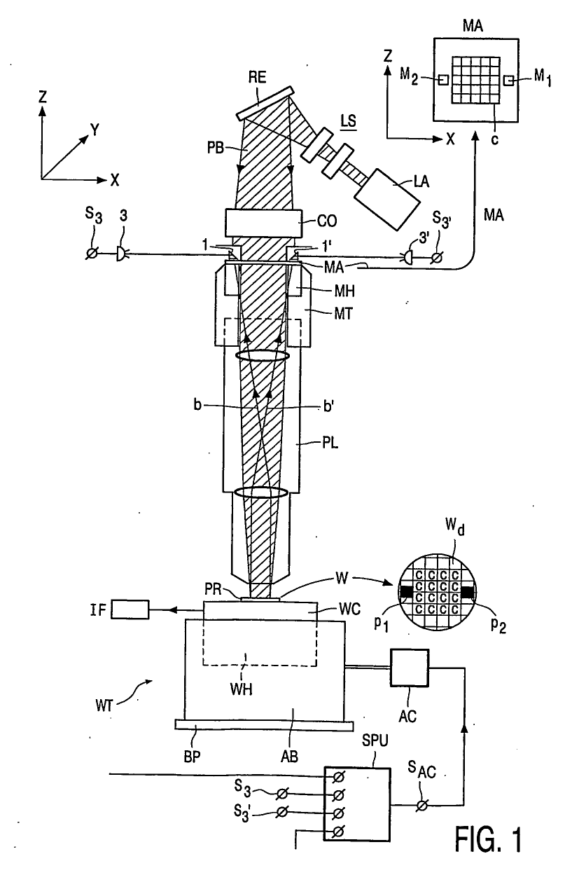

FIG. 1 schematically shows an embodiment of a lithographic projection apparatus by means of which the method can be carried out;

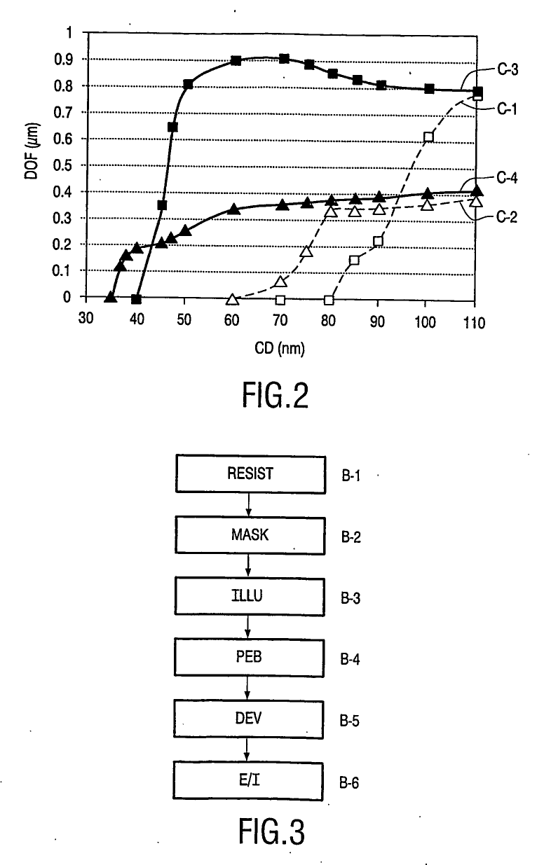

FIG. 2 shows the depth of focus as a function of the CD for a current standard lithographic process and for a process wherein the invention is used;

FIG. 3 shows a block diagram of a standard lithographic process;

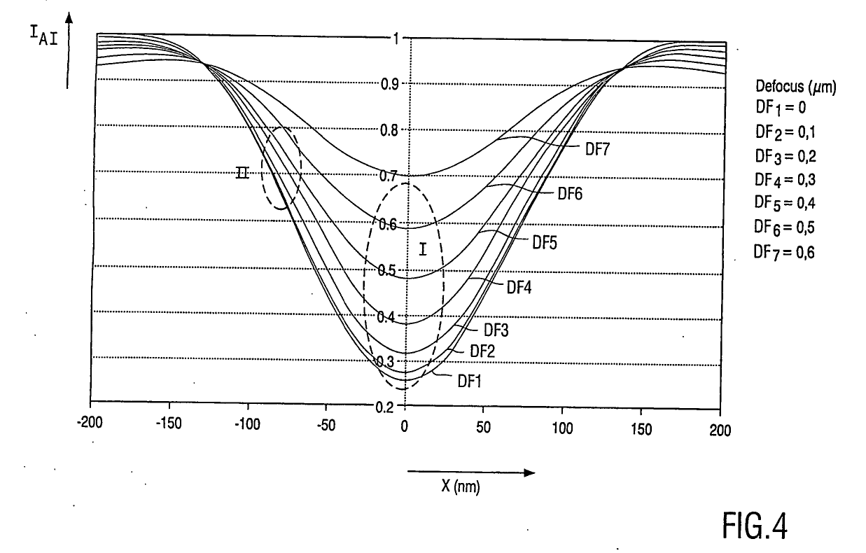

FIG. 4 shows an intensity distribution of an aerial image for different defocus values;

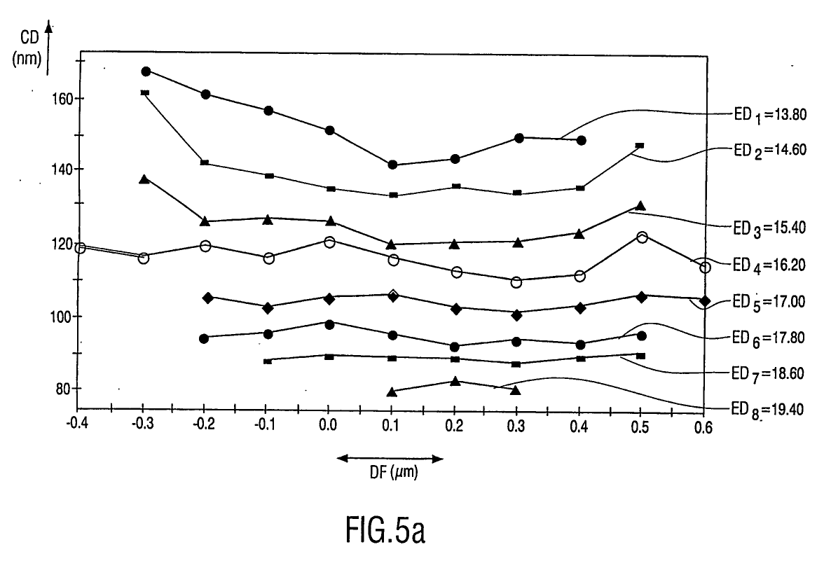

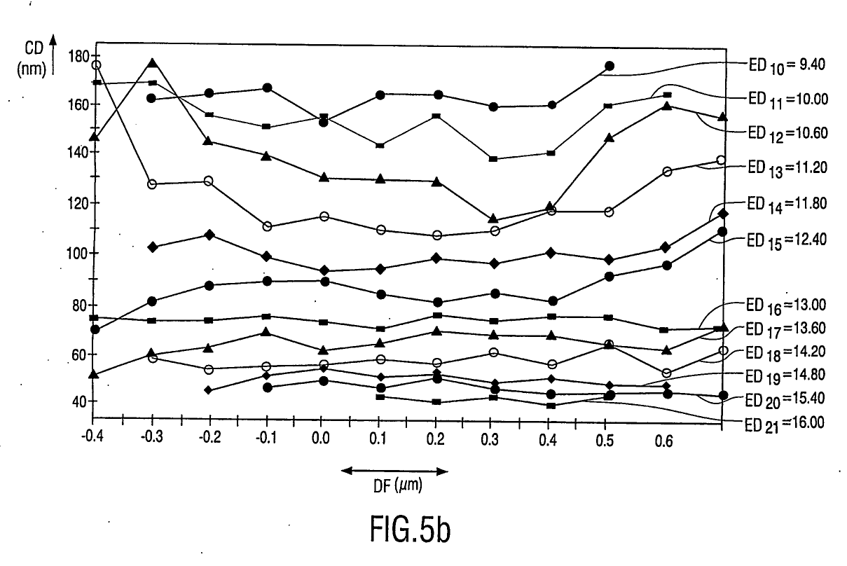

FIGS. 5a and 5b show Bossung plots of a print of a binary mask feature obtained by means of a standard process and a process wherein the invention is used, respectively;

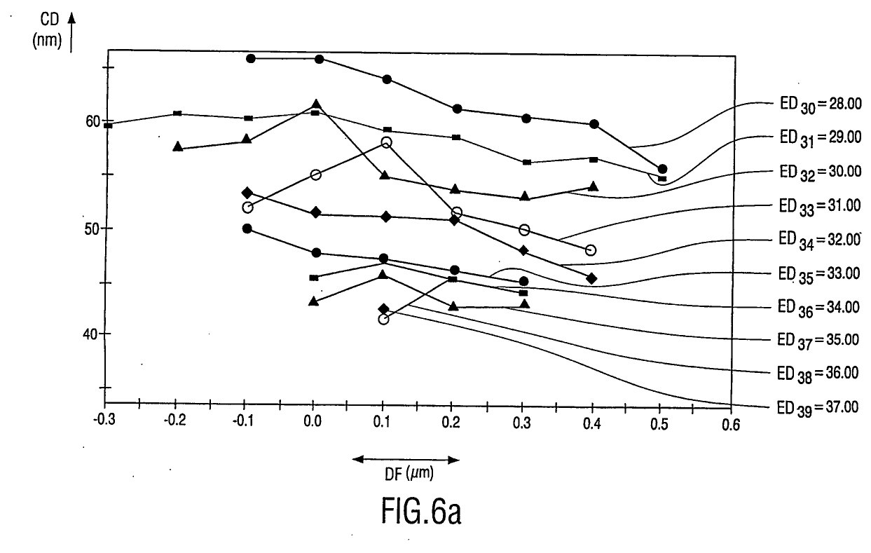

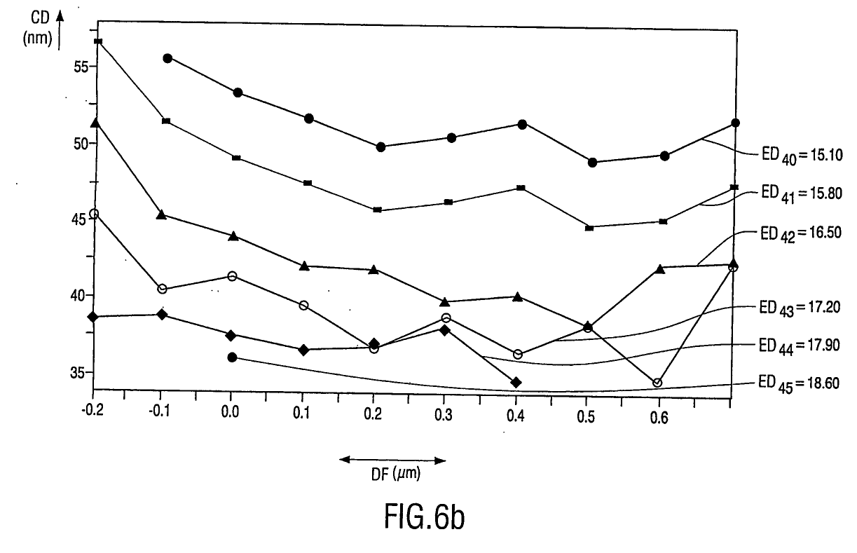

FIGS. 6a and 6b show Bossung plots of a print of a phase shifting mask feature obtained by means of a standard process and a process wherein the invention is used, respectively, and

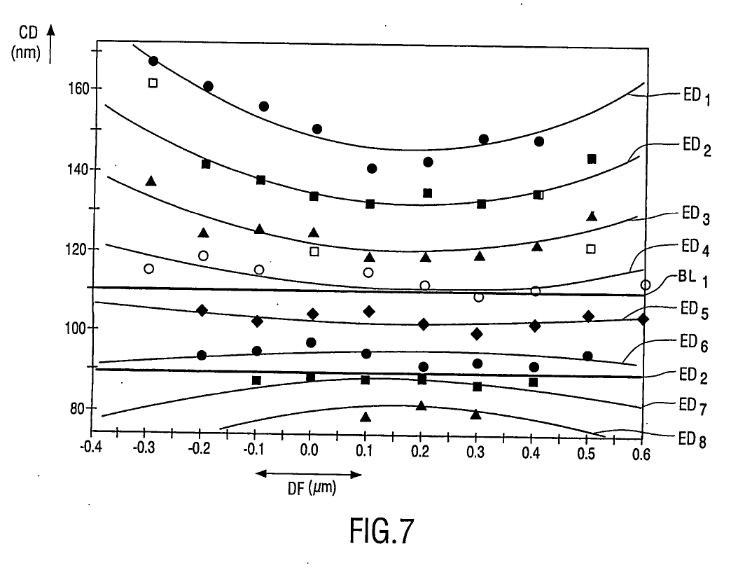

FIGS. 7, 8 and 9 show how the isofocal CD can be tuned by means of changing the post-exposure time duration and the exposure dose.

In the schematic diagram of FIG. 1 only the most important modules of an embodiment of a lithographic projection, or exposure, apparatus are shown. This apparatus comprises a projection column wherein a projection system, for example, a lens projection system PL is accommodated. Above this system a mask holder MH for carrying a mask MA is arranged, which mask comprises a mask pattern C to be imaged. The mask pattern is a pattern of features corresponding to the features to be configured in a layer of a substrate, or wafer, W. The mask holder forms part of a mask table MT. A substrate table WT is arranged in the projection column beneath the projection lens system. The substrate table is provided with a substrate holder WH for holding a substrate, for example a semiconductor wafer, W. A radiation-sensitive layer PR, for example a photoresist layer, is coated on the substrate. The mask pattern C should be imaged a number of times in the resist layer, every time in another IC area, or die, Wd. The substrate table is movable in the X- and Y-direction such that, after the mask pattern has been imaged in an IC area, a next IC area can be positioned under the mask pattern and the projection system.

The apparatus further comprises an illumination system that is provided with a radiation source LA, for example a mercury lamp or an excimer laser like a Krypton-Fluoride excimer laser, a lens system LS, a reflector RE and a collector lens CO. A projection, or exposure, beam PB supplied by the illumination system illuminates the mask pattern C. The projection system PL images this pattern in an IC area on the substrate W.

The apparatus is further provided with a number of measuring systems. A first measuring system is an alignment measuring system for determining alignment, in the XY-plane, of the substrate with respect to the mask pattern C. A second measuring system is an interferometer system IF for measuring the X- and Y-position and the orientation of the substrate. Also present is a focus-error detection system (not shown) for determining a deviation between the focus, or image, field of the projection system and the radiation-sensitive layer PR on the substrate. These measuring systems are parts of servo systems, which comprise electronic signal processing- and control circuits and actuators by means of which the position and orientation of the substrate and the focus can be corrected using the signals delivered by the measuring systems.

The alignment detection system uses two alignment marks M₁ and M₂ in the mask MA, which marks are shown in the right top section of FIG. 1. These marks are, for example, diffraction gratings, but may also be constituted by other marks, like squares or strokes, which are optically different from their surroundings. Preferably the alignment marks are two-dimensional, i.e. they extend in two mutually perpendicular directions, the X- and Y-direction in FIG. 1. The substrate W comprises at least two alignment marks, two of which, P₁ and P₂ are shown in FIG. 1. These marks are positioned outside the area of the substrate W where the images of the mask pattern have to be formed. Preferably the grating marks P₁ and P₂ are phase gratings and the grating marks M₁ and M₂ are amplitude gratings. The alignment detection system may be a double system wherein two alignment beams b and b′ are used for detecting alignment of the substrate mark P₂ with respect to the mask mark M₂ and for detecting alignment of the substrate mark P₁ with respect to the mask mark M₁, respectively. After having traversed the alignment detection system, each of the alignment beams is incident on a radiation sensitive detector 3 and 3′, respectively. Each detector converts the relevant beam into an electrical signal that is indicative of the degree to which the substrate mark is aligned with respect to the mask mark, and thus the degree in which the substrate is aligned with respect to the mask. A double alignment detection system is described in U.S. Pat. No. 4,778,275, which is referred to for further details about this system.

For accurately determining the X- and Y-position of the substrate, the lithographic apparatus comprises a multiple-axis interferometer system, which is schematically indicated by the block IF in FIG. 1. A two-axis interferometer system is described in U.S. Pat. No. 4,251,160 and a three-axis interferometer system in U.S. Pat. No. 4,737,823. In EP-A 0,498,499 a five-axis interferometer system is described, by means of which both displacements along the X- and Y-axis and rotation about the Z-axis and tilts about the X-and Y-axis can be measured very accurately.

As indicated in FIG. 1, the output signal Si of the interferometer system and the signal S₃ and S₃′ of the alignment detection system are supplied to a signal processing circuit SPU, for example a micro computer, which processes these signals to control signals Sac for an actuator AC. This actuator moves the substrate holder WH in the XY-plane, via the substrate table WT.

The output signal of the above mentioned focus-error detection system is employed for correcting focus errors, for example, by moving the projection lens system and the substrate relative to each other in the Z-direction, or by moving one or more lens elements of the projection system in the Z-direction. A focus-error detection system, which may be fixed to the projection lens system, is described in U.S. Pat. No. 4,356,392. A detection system by means of which both a focus-error and a local tilt of the substrate can be detected is described in U.S. Pat. No. 5,191,200.

There is a steadily growing demand to decrease the details, the width of a device feature, or -line, and the distance between neighboring device features, in order to increase the operating speed of the device and/or to increase the number of components in such a device. The smallness of the details which can be imaged in a satisfactory way by a lithographic projection apparatus, of which FIG. 1 shows an example, is determined by the imaging quality and resolving power of the projection system. Conventionally the resolving power, or resolution, has been improved by increasing the numerical aperture NA and/or decreasing the wavelength of the projection radiation. A further increase of the numerical aperture can hardly be expected in practice and a further decrease of the wavelength of the projection beam will pose a lot of new problems.

A more recent development on the way to imaging smaller pattern details with projection systems which can still be manufactured, is the use of a step-and-scanning lithographic apparatus, instead of a stepping lithographic apparatus. In a stepping apparatus, a full-field illumination is used, i.e. the entire mask pattern is illuminated in one operation and imaged as a whole on an IC area of the substrate. After a first IC area has been exposed, a step is made to a next IC area, i.e. the substrate holder is moved in such a way that the next IC area is positioned under the mask pattern. Thereafter this IC area is exposed, and so forth until all IC areas of the substrate are provided with an image of the mask pattern. In a step-and-scanning apparatus only a rectangular or circular-segment-shaped area of the mask pattern is illuminated and hence also a corresponding sub-area of the substrate IC area is exposed each time. The mask pattern and the substrate are moved synchronously through the projection beam, while taking the magnification of the projection system into account. In a continuous process subsequent sub-areas of the mask pattern are then each time imaged on corresponding sub-areas of the relevant IC area. After imaging the entire mask pattern on an IC substrate area in this way, the substrate holder performs a stepping movement, i.e. the beginning of a next IC area is moved in the projection beam. The mask is then set, for example, in its initial position, whereafter said next IC area is scan-exposed. As in the step-and-scanning method only the central part of the image field is used and thus only this part needs to be corrected for optical aberrations, a relatively large numerical aperture can be employed. In this way the width of the device features and their interspaces, which can be imaged with the required quality, can be decreased to a certain degree. However, increasing the density of device patterns by optical means will not be sufficient for next generations of ICs and other devices. Moreover, the theoretical limit, set by the numerical aperture, the wavelength and the scanning principle will not be reached in practice, due to imperfections of the apparatus, like optical aberrations, and imperfections of the lithographic processes.

The use of a projection system, which is capable of forming an image, also called aerial image, in the resist layer, which image has very small lines ( VSL) does not guarantee that correspondingly small device features can be configured in the device substrate layer. When configuring very small features in a substrate layer two main problems arise, namely line collapse and the very high sensitivity of the process to focus variations. For a positive resist line collapse is the phenomenon, that resist is removed from positions where it should remain so that a required feature, or -line, disappears. The influence of focus variations on the capability of the lithographic process to configure small lines is illustrated in FIG. 2.

FIG. 2 shows the depth of focus DOF (in pun) as a function of the required minimum feature width (CD: critical dimension) for a standard process and for a design line width of 100 nm. Curve C-1 represents the case of a dense line, i.e. a line from a pattern having a number of such lines spaced 140 nm apart, whilst curve C-2 represents the case of an isolated line. The pattern and the line are binary mask patterns. A binary mask is understood to mean a mask comprising a transparent substrate, one side of which is provided with a configuration of non-transparent regions, which together represent the design pattern. The non-transparent regions usually are made of chromium. The depth of focus is understood to mean the range of defocus values for which the resulting line width variation remains within plus/minus 10% of the design line width. As mentioned hereinbefore and will be discussed later on, the feature width smaller than 100 nm shown in FIG. 2 can be printed by means of over-exposure of a 100 nm line width pattern. FIG. 2 clearly shows that the depth of focus strongly decreases with decreasing CD, especially for the dense line (curve C-1); the DOF is already as small as 100 nm for a CD of 85 nm. The difference between curve C-1 and the curve for the isolated line C-2 is caused by the difference between the aerial image intensity distribution of an isolated line and a (dense) line forming part of a series of lines.

FIG. 3 shows a block diagram of the lithographic process steps, which are relevant for the present invention. For this and following Figures, it is assumed that a positive resist is used.

Block B-1 denotes the step of providing a substrate layer, which is to be configured with a pattern of device features, with a resist layer and positioning the substrate in a projection apparatus, like that of FIG. 1.

Block B-2 denotes the step of designing and providing a mask, which comprises a mask pattern corresponding to the pattern of the device features to be configured, and placing this mask in the projection apparatus.

Block B-3 denotes the step of illuminating the resist layer via the mask pattern by means of an exposure beam, which provides the required exposure dose. In the exposed portions of the resist acid molecules are freed in a controlled way by means of a quencher, which partly neutralizes the acid molecules.

Block B-4 denotes the step of removing the substrate with the exposed resist layer from the projection apparatus and placing it in oven to undergo post exposure baking during a pre-determined time. In a positive resist the PEB thermally activates the remaining acid molecules, which start to remove the solubility-blocking groups present in the resist polymer chain. This activity is known as de-protecting the resist. As a result, the resist becomes soluble once de-protection has reached a given level, or threshold. Given a fixed PEB time duration, aerial image intensity at least equal to a threshold intensity is needed to render the resist soluble.

Block B-5 denotes the step of removing the substrate from the PEB device and placing it in a developer solution to remove the soluble portions of the resist so that a resist pattern is obtained.

Block B-6 denotes the step of removing the substrate from the developer solution and placing it in an etching device and/or an implantation device. Thereby material is removed from and/or added to layer regions delineated by the resist pattern D obtained in block B-5 so that IC regions with required properties are obtained. For the manufacture of a complete (IC) device, the series of lithographic steps shown in FIG. 3 and preparatory and intermediate steps are repeated a number of times equal to the number of device substrate layers to be configured.

For configuring device features, or -lines, having sub 100 nm width, over-exposure, i.e. exposure using an enlarged radiation dose, can be used. The effect of over-exposure is that the threshold aerial image intensity is reached also in resist areas close to the center of the aerial image intensity minimum, which center corresponds to the center of the line to be formed. This means that the resist in these areas becomes soluble also so that, after the developing step, a resist line smaller than the aerial image line will remain, which very small line is denoted by VSL.

A disadvantage of VSL printing by means of over-exposure, which disadvantage is very important in practice, is that the printed line width is very sensitive to focus variations, as shown in FIG. 2 by means of curves C-1 and C-2, and for line collapse. The strong sensitivity to focus variation can be understood by looking at the aerial image behavior when focus errors occur. FIG. 4 shows, for a 100 nm isolated line in a binary mask pattern, the aerial image intensity I_{AI} (in arbitrary units) as a function of the position x in the resist layer for different defocus (DF) values, from 0 to 0.6 μm in steps of 0.1 μm. For each defocus value a separate curve DF1-DF6 is shown. Position x=0 corresponds to the center of the intensity minimum in the aerial image, thus to the position where the very small line has to be printed. In the area I around the position x=0 the aerial image intensity sharply increases with increasing defocus. For the feature configured in the substrate layer this would mean that its width is very sensitive to focus errors. This, together with line collapse, causes a very small depth of focus. In other words there is a small or even no process window for printing very small lines if over-exposure is used. Another disadvantage of the over-exposure technique is that a lot of resist material on top of the resist profile gets lost.

According to the invention, for VSL printing small exposure doses together with long PEB time duration are used. For a small exposure dose, the small amount of acid molecules in the vicinity of the aerial image intensity minimum, thus in region I in FIG. 4, that is generated as such is insufficient to render the polymer resist soluble in this region. The threshold value for developing the resist will only be reached in a region II remote from region I. In region II the aerial image intensity is considerably less sensitive than in region I. If only a low exposure dose were used, rather broad lines would have been printed. However a more efficient use is made of the small amount of generated acid molecules by extending the duration of the post exposure baking, or de-protecting, step. This allows the same amount of acid molecules to de-protect more polymer sites. The smaller acid concentrations close to the aerial intensity minimum now becomes sufficient to render the resist soluble so that a very small resist line remains after development. Since the extended PEB step and the more efficient use of the acid molecules are not influenced by focus variations, which are caused by the optical system, a large improvement in depth of focus is obtained.

The new processing technique also provides a solution to the problem of line collapse. The effect of using a lower exposure dose and an extended PEB time duration is that the slopes of the resist profile are more positive. Such a slope is understood to mean the transition from the top of a resist feature, or -line, to its base, i.e. the wall of such line. For a resist line having positive slopes the top is smaller than the base. Such a resist line is more stable during succeeding processing steps and less sensitive to line collapse. The longer PEB step may also provide an improved adhesion of the resist polymer to the device substrate, which also prevents line collapse.

The combination of the considerably smaller sensitivity to focus variations, i.e. the larger DOF, of the new processing technology and the considerably reduced chance of line collapse results in a substantially enhanced capability to print very small lines. This is illustrated in FIG. 2 by curves C-3 and C-4. These curves show, for the same dense line and for the same isolated line used for curves C-1 and C-2, respectively, the depth of focus as a function of the required CD. It is immediately clear that the new processing technology allows printing of considerably smaller CDs and provides substantially increased DOF for small CDs, down to 50 nm and smaller.

The data of FIG. 2 are calculated from the Bossung plots shown in FIGS. 5a and 5b. It is usual to characterize a lithographic printing process by making a series of prints of the same feature, or -line, while changing exposure dose and focus setting in discrete steps across the substrate. The printed lines are observed, for example by means of a scanning electron microscope (SEM) so that a Focus-Exposure Matrix (FEM) is obtained. When the measured CD values are plotted as a function of dose and focus, a so-called Bossung plot is obtained. FIG. 5a shows a Bossung plot obtained from a binary mask having a pattern of 100 nm chromium lines spaced at 140 nm by means of a current standard process, using a PEB time duration of 90 sec. A resist layer having a thickness of the order of 300 nm and comprising a resist of the type AR 237, which is a well-known resist for lithography, was used. CD values (in nm) are plotted as a finction of defocus values DF (in μm) for eight different exposure doses, ranging from 13,80 to 19,40 mJ/cm² (graphs ED₁ to ED₈). FIG. 5a shows that for the denoted process parameters the smallest line width (CD) that can be printed is 80 nm. For this CD a change in focus of only 200 nm can be tolerated, i.e. the DOF is only 200 nm. If larger focus error occur the 80 nm line width cannot be printed.

FIG. 5b shows the Bossung plot obtained from the same binary mask and by means of the same process, with the exception that the exposure doses are smaller and that the PEB time duration is substantially extended, to 260 sec. Twelve different exposure doses, in the range from 9.40 to 16.00 mJ/cm², were used (graphs ED₁o to ED₂₁). FIG. 5b shows that under these circumstances line widths down to 40 nm can be printed and that much larger focus variations can be tolerated. For a 80 nm line width a focus variation of 1200 nm is tolerable and for 45 nm line width the tolerable focus variation is 900 nm.

The enhancement with respect to the minimum CD and focus insensitivity of the new process is obtained without introducing dependency on the pitch and orientation of features in the mask pattern, as is the case for alternative conventional enhancement techniques like dipole and quadrupole illumination.

If desired, the new process can also be combined with a conventional method for resolution enhancement, by replacing the binary mask pattern by a phase-shifting mask (PSM) pattern. In a phase shifting pattern, the borderlines of a feature are marked by areas, each of which introduces a phase shift in the illumination beam. By interference of the beam portions from these areas, a line width can be printed which is smaller than the imaged line width from the same feature of a binary mask. This is illustrated in FIG. 6a, which shows a Bossung plot of a pure phase shifting mask line obtained with ten different exposure doses (graphs ED₃₀ to ED₃₉) ranging from 28.00 to 37.00 mJ/cm². The CD values are obtained with a conventional standard process using a PEB exposure duration of 90 sec. FIG. 6a shows that the smallest line width (CD) that can be printed in principle is 42 nm. However the DOF is very small, only 100 nm.

If for printing of the same phase shifting mask line lower exposure doses and a PEB time duration of 260 sec is used, the Bossung plot of FIG. 6b is obtained. FIG. 6b shows CD values obtained with six different exposure doses (graphs ED₄₀ to ED₄₅), ranging from 15,10 to 18,60. The new process now allows printing line widths down to 36 nm and tolerating much larger focus variations, up to 580 nm for 37 nm wide lines.

The mask pattern from which the Bossung plots of FIGS. 6a and 6b are obtained comprises only phase shifting areas. Such a mask pattern is also called a chrome-less pattern because it does not comprise non-transparent areas. The new method can also be used with a mask pattern comprising features in the form of non-transparent areas on the borders of which phase areas are arranged.

A second aspect of the invention relates to adaptation of the process-determined isofocal CD to the CD of the device feature design. The isofocal CD relates to the capability of the lithographic process to reduce the effects of changes in process parameters. The most severe effects are caused by changes in exposure dose and focus variations, which is clear from the Bossung plots shown in FIGS. 5a, 5b, 6a and 6b. However, for a specific feature width, which is called the isofocal CD, very large focus and dose variations can be tolerated. This isofocal CD is highly dependent on the surroundings of the feature in the design pattern and on the resist that is used. Unfortunately the process-determined isofocal CD usually does not coincide with the desired feature width in the design, hereinafter referred to as design CD. This means that the process latitudes, or tolerances, usually are very small, which makes it very difficult to run the lithographic process adequately.

As the isofocal line is determined, to a large extent, by the aerial image that is offered to the resist layer and variations therein caused by focus variations, one could try to change, or improve this image to reach correspondence between the design CD and the isofocal CD. However, the aerial image generally is an essential element of the IC design. This aerial image can only be improved in the desired direction by means of expensive and non-flexible means, like the use of phase shifting masks or extreme off-axis illumination, like dipole and quadrupole illumination. The results of the latter types of illumination are highly dependent on the orientation and the periodicity (the pitch) of the features in the mask pattern. Another option to render the isofocal CD equal to the design CD could be the use of another resist material. This would shift the isofocal line, however, in a non-controllable way. Since a change of resist material also affects other aspects of the lithographic process, this is not a real solution.

To reach correspondence between the design CD and the isofocal CD, the invention uses the fact that during the PEB step of a positive resist the acid molecules diffuse through the resist polymer from areas which have received maximum aerial image intensity to areas, which have received minimum intensity. As a result, the acid concentration profile obtained after the PEB step has been carried out is different from the original acid concentration profile, which was defined by the aerial image intensity distribution. The PEB step also influences the different acid concentration profiles related to an aerial image feature, which different profiles would result from various focus positions of the aerial image and thus shifts the intersection of these profiles. The position where the different focal lines intersect each other will change, for example, because most diffusion of acid molecules occurs at the acid concentration profile showing the largest slope. Shift of the intersection position means shift of the isofocal line. The invention uses the PEB time duration to tune the acid diffusion extend and thus to control the final acid concentration profile and to tune the isofocal CD, which is related to said intersection. For, with a longer PEB time the diffusion takes place over a longer extent and the final acid profile is different from that obtained with a shorter PEB time.

Since the PEB time duration determines how effectively acid molecules, which are generated by the aerial image exposure of the resist, are used to de-protect the resist polymer, the exposure dose should be adapted to avoid that too much resist material would be de-protected and removed during the developing step. As the PEB time duration and the exposure dose determine how close to the center of a resist line, or -feature, resist becomes de-protected, and hence soluble, these parameters control the isofocal CD.

The effect of the simultaneous tuning of the PEB time duration and the exposure dose is made clear by means of FIGS. 7-9. FIG. 7 shows a Bossung plot obtained by means of a current standard process, using a PEB time duration of 90 sec, from a dense line, of a pattern of 100 nm chromium lines spaced at 140 nm, in a binary mask. The exposure doses are the same as those used for obtaining the plot of FIG. 5a so that the plot of FIG. 7 is similar to that of FIG. 5a. FIG. 7 shows best fit Bossung curves for each exposure dose (ED₁-ED₈), instead of the lines connecting the measured CD values of FIG. 5a, to indicate to which degree CD values belonging to a given exposure dose are isofocal. The smaller the curvature of these curves, the better the isofocal situation is approximated for all CDs of the relevant exposure dose. For the process conditions of FIG. 7 the isofocal CD is situated around the design CD of 100 nm. The thick straight lines BL₁, BL₂ denote the boundaries of the CD values that are still tolerable. Generally, these lines are put at +10% and −10% of the design CD value.

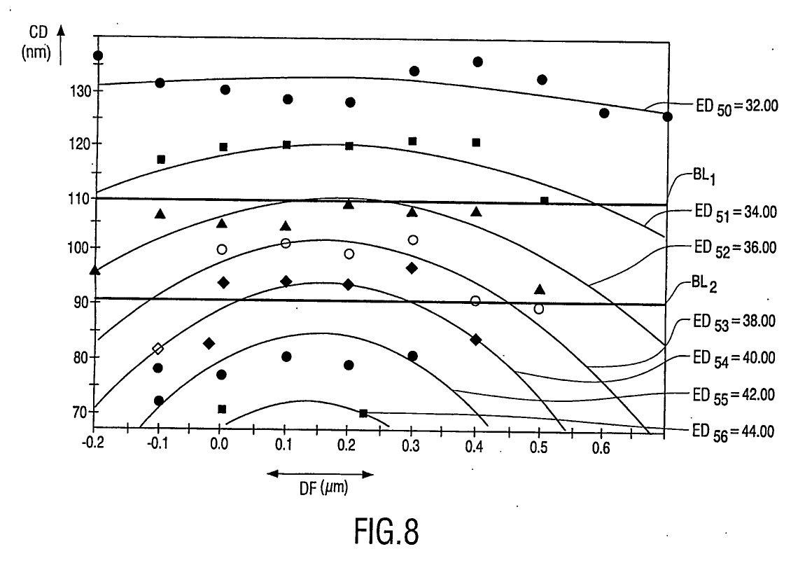

FIG. 8 shows the Bossung plot obtained from the same binary mask and by means of the same process, with the exception that the PEB time duration has been lowered to 30 sec and that the exposure doses have been increased. Seven different exposure doses, in the range of 32,00 to 44,00 mJ/cm², were used (curves ED₅₀ to ED₅₆). For the process conditions of FIG. 8 the isofocal CD is situated around 130 nm; the curve ED₅₀ for an exposure dose of 32,00 mJ/cm² shows the smallest curvature. These conditions thus are not suitable for printing a design CD of about 100 nm between the boundary lines at 90 and 110 nm, respectively, but are very suitable for printing a design CD of about 130 nm, the boundary lines being shifted to 120 and 140 nm, respectively. For the higher exposure doses of FIG. 8 the quencher is annihilated completely before substantial diffusion of acid molecules starts.

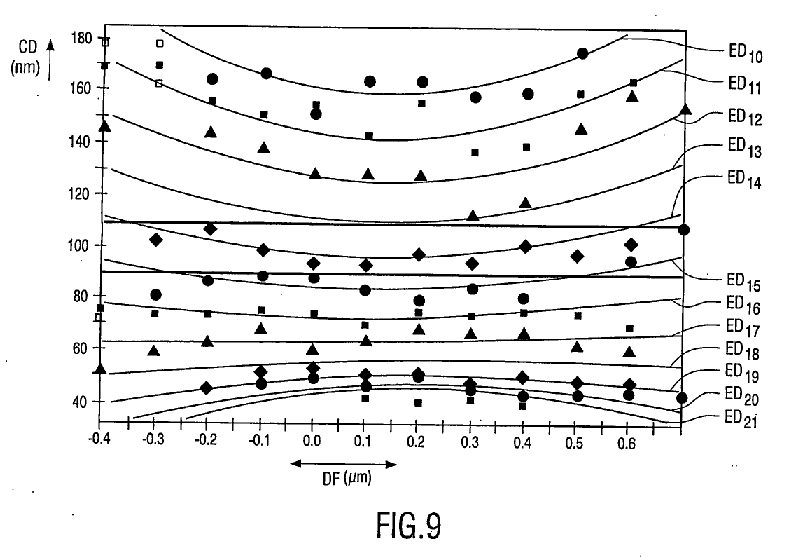

FIG. 9 shows the Bossung plot for the same binary mask as that used for FIGS. 7, 8 and FIG. 5b. Now a substantially extended PEB time duration of 260 sec has been used, which is the same as that used for obtaining the Bossung plot of FIG. 5b. Also the exposure doses of FIG. 9 are the same as those of FIG. 5b so that the two Figures, show similar Bossung plots. In FIG. 9 curve ED₁₇, for an exposure dose of 13.60 mJ/cm², shows the smallest curvature so that for the process conditions denoted in this Figure the isofocal CD is situated around 60 nm. FIG. 9 also demonstrates that for the substantially increased PEB time duration a broad range of CD values, between 50 and 90 nm, is quasi-isofocal, which means that the curvature of the Bossung curves for CD values different from the isofocal CD is smaller. This implies that, by the very simple extension of the PEB step, the lithographic process in general becomes much less sensitive to focus variation for a broad range of different patterns of features on the substrate (wafer). In addition, the new process is independent of the orientation and the periodicity of the features in the pattern and therefore can be used for a wide variety of applications. For the lower exposure doses of FIG. 9 the quencher is present during the entire PEB step.

The invention thus provides a method, which allows tuning of the isofocal CD in an independent way and without changing the aerial image. This method can be easily implemented in current lithographic processes and provides great advantages. It allows tuning of the isofocal CD such that it corresponds with the design CD. This means that the range of applications for which a given resist can be used is substantially enlarged. The capability to tune the isofocal CD provides the possibility to use the largest possible process window (process latitudes) under any circumstances and for any pattern structure that is to be printed. The method can also be used to tune the process so as to have the largest overall performance for printing device features having different sizes simultaneously.

The invention has been described by means of a positive resist, but can also be employed in a lithographic process wherein a negative resist is used. The measures according to the invention will generate similar effects in a negative resist, yet on the resist protecting mechanism, i.e. making soluble resist insoluble, instead of on the resist de-protecting mechanism.

The invention can also be used to change the slope of transitions between non-soluble resist material and soluble resist material from a negative slope to at least a zero slope and preferably a positive slope.

In currently used lithographic processes wherein the PEB time duration is, for example, 90 sec, the acid concentration profile in the resist layer may have negative slopes, which means that the transitions between non-soluble and soluble resist material have a negative slope. For a positive resist a negative slope means that the top surface area of a required, non-soluble resist, feature is larger than its base area. Such a resist feature is less stable during the developing step than a resist feature having positive slopes, i.e. having a top surface area smaller than its base area. For a negative resist feature a negative slope means than the top surface area of a required, soluble, resist feature is smaller than its base, which may cause difficulties in removing the soluble resist portion. As the PEB step changes the acid concentration profile in the resist layer and thus the position and slopes of the transition between non-soluble and soluble resist material, the PEB time duration can be used as a process parameter to change the slopes.

The results denoted in FIGS. 2, 5b, 6b, 7, 8 and 9 were obtained by means of a resist layer having a thickness of about 300 nm. This indicates that the invention works very well with such a resist thickness, which is a conventional one. The invention thus can be used in conventional lithographic process circumstances.

If, according to the invention a longer PEB time is used, the magnitude of slope of a transition between non-soluble and soluble resist material may change. For example a slope of 90°, obtained with a conventional process using a PEB time of 90 sec, may change to a slope of, for example, 80° if the PEB time is extended to 180 sec. A slope of 90° means that a fictive wall separating non-soluble and soluble resist material is perpendicular to the surface planes of the resist layer. The change in slope magnitude is due to absorption of exposure radiation by the resist layer, which causes the exposure intensity at the top of the layer to be larger than at the base of the layer. The extended PEB time may cause in a positive resist the slope magnitude to become too small and in a negative resist the negative slope magnitude to become too large. To counteract the varying absorption over the resist thickness, underlying the slope problems measures can be taken, which are different for a positive resist and a negative resist. For a positive resist so-called surface inhibition may be used, which means that less radiation is absorbed at the top of the resist layer. For as negative resist surface the slope problem can be solved by using a resist that shows, for the conventional process, a positive slope, which is obtained by strong surface enhancement, and to increase the dissolution rate during development step by using a developer solution having a higher developer concentration. With respect to the development step, the processes for the positive resist and for the negative resist are no longer symmetrical; for the negative resist a higher concentration developer is used to avoid a negative slope. By using the above additional measures, the method of the invention is improved..

Using a longer PEB time may affect the throughput of the lithographic process. Throughput is understood to mean the number of substrates that can be processed in a unit of time. The exposure time of a lithographic projection (exposure) apparatus is for example 90 sec. If, as is usual in a conventional process, the PEB time is also 90 sec, a steady flow of exposed substrates from the exposure apparatus to the PEB device, also called hot plate, can be maintained. If the PEB time is, for example 260 sec, a substrate that has been exposed has to wait 170 sec before it can be placed in the PEB device, which means that the throughput of the process is considerably decreased.

By using a number of PEB devices corresponding to the ratio of the PEB time duration and the exposure time for one substrate, the high throughput of the process can be maintained. For the given example with an exposure time of 90 sec, inclusive of alignment of the substrate relative to the mask pattern, and a PEB time of 260 sec, three PEB devices will be used. If a first exposed substrate is transported to the first PEB device, a second exposed substrate to the second PEB device, a third exposed substrate to the third PEB device, a fourth exposed substrate to the first PEB device and so on, the original high throughput can be maintained, effective use being made of the fact that at an IC (device) manufacturing site, also called a Fab, a number of hot plates are present, which are not in use simultaneously.

A general problem encountered in lithographic processes is that the feature printed from a dense line having a given design CD, thus a CD in a mask pattern, is broader than the printed feature from an isolated line having the same design CD. An isolated line, or feature, is understood to mean a feature having no neighboring features in a surrounding area of a size of the order of the feature width. A dense line, or feature is understood to mean a feature, which forms part of a series of features at a mutual distance in the order of the width of the feature. For example, an isolated feature having a design CD of 100 nm is printed as a feature having a width of 90 nm, whilst a dense feature has a width of 110 nm. To solve this problem, i.e. reduce or eliminate the difference in printed width, the isodense bias principle can be used. This principle is based on optical proximity correction (OPC). OPC means that in the neighborhood of a design device feature one or more additional features are arranged. The additional features are so small that they are not imaged as such, but they do influence the wave front of the exposure beam portion that images the design feature and thus the image of the design feature. By means of specific OPC features in the mask pattern the printed feature width from a dense feature and from an isolated feature can be made equal to each other.

However, it was discovered that an increase of the PEB time causes an enlargement of the difference between the width of a printed dense feature and the width of a printed isolated feature. For example, if the PEB time is increased from 90 sec to 260 sec, the width of the printed isolated feature will be 100 nm and that of the printed dense feature will be 130 nm. The original OPC features cannot correct the difference in width.

According to the invention this problem can be eliminated if in the design stage the envisaged PEB time duration is used as a design parameter to determine the design width of the design pattern of features.

The OPC features for printed feature width correction can now be adapted to the PEB time to be used so that the width difference can be eliminated again. In this way a further refinement of the method is obtained. It is also possible to adapt other OPC features, which are used for purposes other than printed line width control, to the PEB time duration chosen.

In the above explanation it has been suggested that a printed feature would have the same width as the corresponding feature in the mask pattern. This would imply that the projection system is a 1:1 imaging system. Usually a lithographic projection apparatus has a magnification of, for example 1/4 or 1/5 , which means that a mask feature has a width that is four or five times the width of the printed feature. The magnification of the projection system was not taken into account in order to keep the explanation as simple as possible.

The purpose of the invention is to improve a method of level-by-level manufacturing of a device, which comprises device features distributed over different levels, which method employs a number of processes for configuring device features, each process for one device level. By implementing the invention in at least one of the configuring processes the invention is also embodied in this method.

As the new pattern forming method results in a device having smaller minimum device features and/or better defined feature sizes, the invention is also embodied in such a device.

Although the invention has been described by means of a specific lithographic projection apparatus and by means of the manufacture of ICs, it is not limited thereto. The invention can also be used in the manufacture of other devices having small feature sizes, like crystal panels, thin-film magnetic heads, integrated and planar optical systems etc. Moreover, the invention can be used in combination with any projection apparatus, which is capable of forming the required aerial image.

1. A method of forming a pattern of features having sub-micron width in a device substrate layer, which method includes the steps of
forming a resist layer of one the resist types: positive resist and negative resist on the substrate;
providing a mask having a mask pattern corresponding to the pattern of features to be formed in the substrate layer;
illuminating the resist layer via the mask pattern by means of a projection beam providing an exposure dose, thereby generating an acid concentration profile in the resist layer around each imaged feature;
heating the illuminated resist layer during a post exposure baking (PEB) step so that, starting from the highest illumination intensity areas the material of a positive resist layer becomes soluble and the material of a negative resist layer becomes insoluble, respectively in a developer solution;
developing the resist layer in the developer solution so that resist material is removed from resist layer areas having a solubility above a threshold value so that a resist profile pattern is obtained;
removing material from or adding material to areas of the substrate layer, which areas are delineated by the resist profile pattern, so that the required pattern of features is formed in the substrate layer, characterized in that the time duration of the PEB step and the exposure dose are adapted to the design width of the features to be formed.

2. A method as claimed in claim 1, wherein during the PEB step transitions between non-soluble and soluble resist material initially have a negative slope, characterized in that an enlarged PEB time duration is used to push the slopes to at least zero slopes and preferably positive slopes.

3. A method as claimed in claim 1, characterized in that a resist layer having a thickness in the range of 300 to 350 nm is used.

4. A method as claimed in claim 1, characterized in that a resist having an adapted radiation absorption gradient is used to reduce changes in the slopes of transitions between non-soluble and soluble resist material which are due to extended PEB time duration.

5. A method as claimed in claim 1, using a same mask pattern for successively forming a same pattern in a substrate layer of a batch of substrates by means of a same lithographic exposure apparatus, characterized in that for carrying out the PEB steps for successively exposed substrates a number of PEB devices is used, which number substantially corresponds to the ratio of the PEB time duration and the exposure time for one substrate.

6. A method as claimed in claim 1, wherein the step of providing a mask pattern includes designing a pattern having optical proximity correction features, characterized in that in the design stage the envisaged PEB time duration is used as a design parameter to determine the design width of the design pattern of features.

7. A method as claimed in claim 1, characterized in that the time duration of the PEB step is enlarged to form device features having a smallest dimension, which is smaller than the corresponding dimension in an aerial image of the mask pattern, the aerial image being formed by the projection beam in the resist layer.

8. A method as claimed in claim 7, characterized in that the PEB step is performed during at least 140 seconds and that a correspondingly smaller exposure dose is used to obtain feature widths smaller than 80 nm.

9. A method as claimed in claim 1 for use in a lithographic process having an isofocal CD, characterized in that the isofocal CD is tuned to the design CD by adapting the PEB time duration and the exposure dose.

10. A method as claimed in claim 1, characterized in that use is made of a binary mask pattern.

11. A method as claimed in claim 1 characterized in that use is made of a phase shifting mask pattern.

12. A method of level-by-level manufacturing of a device, which comprises device features distributed over different levels, which method employs a number of processes for configuring device features each process for one device level, characterized in that at least one of the configuring processes comprises the method as claimed in claim 1.

13. A device manufactured by means of the method as claimed in claim 1.
